(19) United States
(12) Patent Application Publication
(10) Pub. No.: US 2008/0286031 A1
(43) Pub. Date: Nov. 20, 2008

(54) Device for Dispensing Doses of Fluid Substances of Variable Viscosity and Density

(76) Inventor: Gianfranco de Paoli Ambrosi, Salo (Brescia) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/092,310

(22) PCT Filed: Oct. 30, 2006
(86) PCT No.: PCT/IT06/00762

§ 371 Date: May 1, 2008

(30) Foreign Application Priority Data
Nov. 3, 2005 (IT) BS2005A000131
Feb. 20, 2006 (IT) BS2006A000033

(51) Int. Cl. B43K 5/06; B43K 1/06; A47L 13/22; B43K 5/10; G01F 11/00

(52) U.S. Cl. 401/180; 401/149; 401/151; 401/176; 401/178; 401/188 R; 401/209; 401/265; 401/278; 401/279; 401/284; 401/286; 222/386

(57) ABSTRACT

The invention concerns a device for dispensing doses of fluid substances with different viscosities or densities, comprising a container (11), a piston (25) housed and sliding in a chamber (24) formed by a portion of the container, a load tank (33) formed by a remaining portion of said container and designed to contain the substance to be delivered, a metering mechanism (12) associated and moving with the piston (25), a preloaded thrusting device (27) associated with the piston with the metering mechanism to push it normally towards the substance in the load tank, and blocking means (12) between the metering mechanism and the container to alternately stop and release the piston to have it move forward under the thrust of said preloaded flexible device in lengths corresponding to a dose of the substance.

### FIELD OF INVENTION

The present invention concerns an innovative device directed mainly, but not only, at containing either fluid substances with variable viscosities and densities or powders also with variable granulometry, to be dispensed by means of an applicator or distributor in preset doses for their correct use.

### STATE OF THE ART

On the one hand, metering devices for fluid substances with a container containing an amount of the substance to be delivered in doses are known, but which require however manual intervention either through the use of a screw or some others means to expel and distribute, each time, a set dose of the substance in the container.

On the other hand, however, the fluid substances to be metered may be different depending on their properties and ways in which they are to be used. Due to their state of aggregation they may in fact have different viscosities or densities, which in itself creates a problem to obtain regular, calibrated metering, each substance behaving differently and requiring appropriate and specific means of metering.

In general, the devices known up to now require the help of a source of energy, even if manual, for each manoeuvre, that is to say each time they are used.

### OBJECTS OF THE INVENTION

One object of this invention is to effectively resolve such a problem by using a device for the abovementioned use whose operation is carried out by means of a potential pre-established energy source, which, when released on command, causes a gradual movement, in stages, of a propelling element suitable for acting on the substance in question so as to cause its delivery in preset doses.

Another object of the invention is to propose a device conceived to contain and distribute fluid substances in an automatic way and pre-metered for single delivery, despite the viscosity and density of the fluid.

Yet another object is to propose and provide a user friendly and reliable device, operating easily and repetitively by means of a simple pressure on a metering switch, without requiring further intervention on the part of the device components.

Yet another object of the invention is to provide a metering-deliverer device with which it is possible to deliver regular doses independently of the viscosity or density of the substance, and in which a slight forward movement of the thrusting element, by means of a pre-established energy source, enables the doses to be increased to meet requirements.

A further object of the invention is to provide a metering-deliverer device which can be both disposable and rechargeable for continuous use.

These objects and the implicit advantages deriving from them are achieved with a device to dispense preset doses of fluid substances with different densities comprising a cylinder shaped container with a proximal closed end and a distal end with an opening, a piston, housed and moving in a chamber formed by a section of said container, contiguous to said closed end, a load tank formed by the remaining portion of said container, contiguous to the open end and designed to contain the fluid substance to be delivered, a metering mechanism placed in said chamber, associated and moving with the piston in said container, a pre-loaded flexible device associated with said piston and with said metering mechanism to push it normally towards the substance in the load tank, a blocking means between the metering mechanism and the container cylinder to alternately stop and release said piston, to govern its forward movement in stages under the thrust of said pre-loaded flexible device, corresponding, at each stage to the delivery of a dose of substance from the distal opening of the chamber towards an applicator coupled to the container cylinder.

Furthermore, between the load tank and the applicator a single-acting valve and a collection tank can be inserted, with the single-acting valve usually closed and which opens only under the thrust from the piston on the substance in the load tank.

### BRIEF DESCRIPTION OF THE DRAWINGS

The invention will however be illustrated more in detail in the continuation of this description made in reference to the enclosed indicative and not restrictive drawings, in which:

FIG. 1 shows a cross section view of a device according to the invention,

FIG. 2 shows a proximal section of the container cylinder of the device,

FIGS. 3 A, B and C show, respectively, front, rear and side views, of the metering mechanism,

FIGS. 4 A, B and C show, respectively, front, rear and side views of the proximal section of the cylinder in FIG. 2 together with associated metering mechanism,

FIG. 5 shows a cross section according to arrows V-V in FIG. 4 A,

FIG. 6 shows an exploded view of a distal portion of the container cylinder of the device and elements associated with it;

FIG. 7 shows the external view of an example of a finished device; and

FIG. 8 shows, the device assembly as seen in transparence.

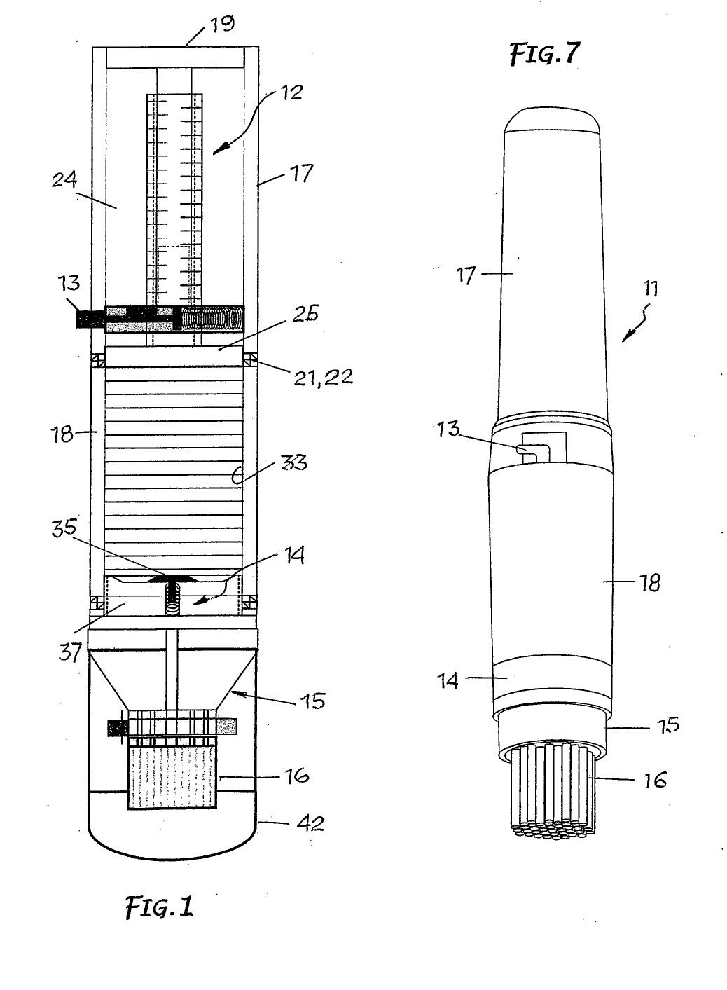

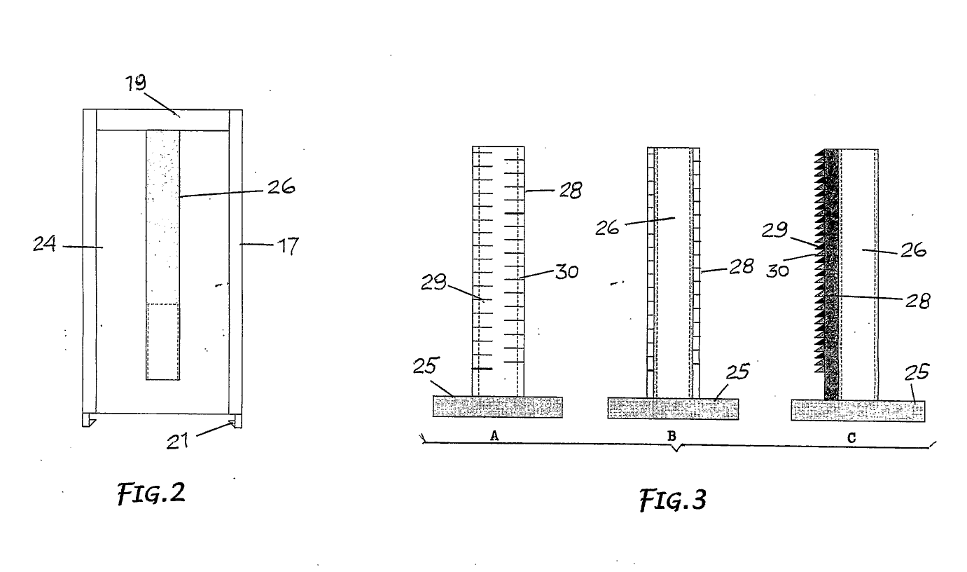

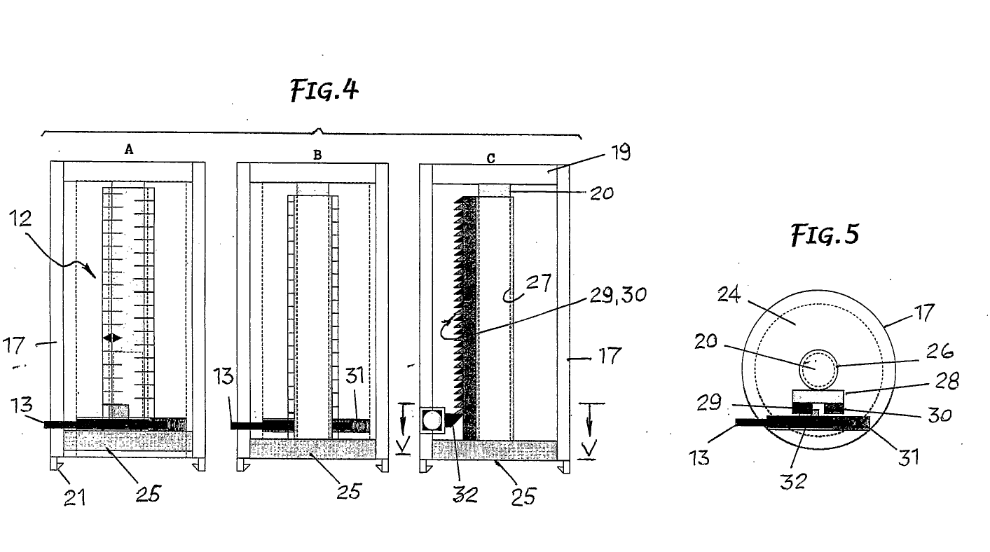

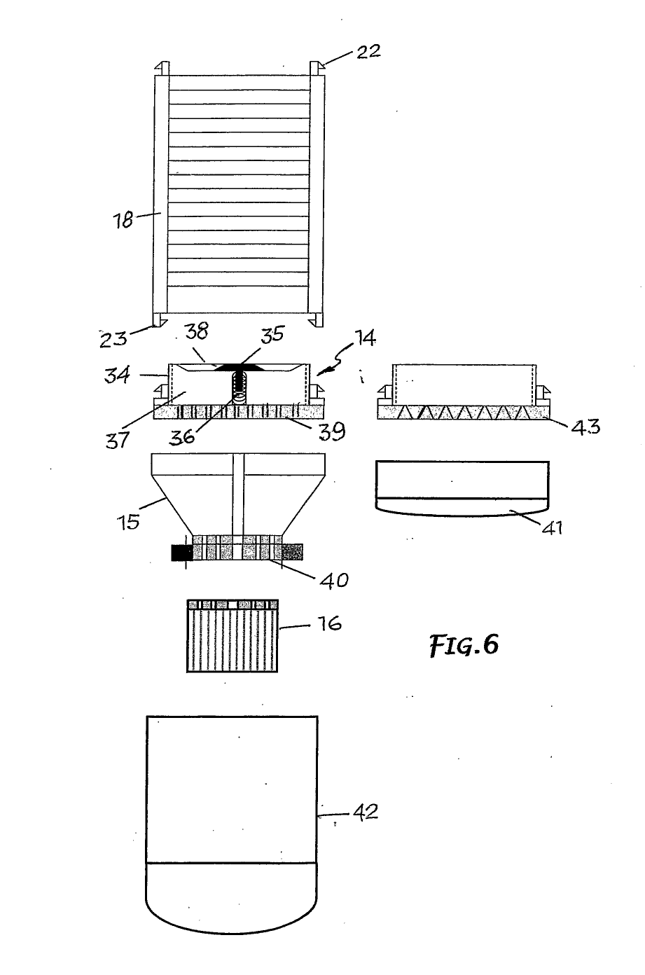

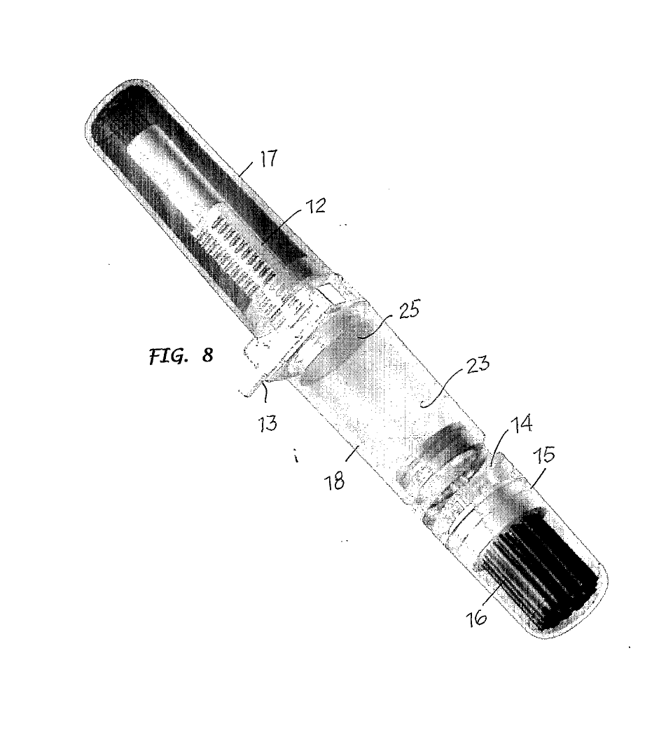

### DETAILED DESCRIPTION OF THE INVENTION

The proposed device basically comprises a container 11, a metering mechanism 12, a control pushbutton 13, a single-acting valve 14, a collection tank 15 and an interchangeable applicator 16 combined together to operate. These components can be press-forged in a plastic material.

Preferably, the container 11 is made up of a proximal cylinder 17 and a distal cylinder 18 aligned and possibly permanently joined together.

In detail, the proximal cylinder 17 has one end closed by a wall of the head 19 from which a guide shank 20 extends facing towards the inside of the cylinder. The opposite end of the proximal cylinder 17 is open and equipped with a peripheral attaching system 21, designed to couple and form a seal with complementary coupling systems 22 and an adjacent end of the distal cylinder 18. The other end of the latter is open and also equipped with a coupling system 23 so as to be able to apply a single-acting valve 14 to which the collection tank 15 is attached together with the applicator 16.

The proximal cylinder 17 forms a chamber 24, and the metering mechanism 12 is positioned in said chamber. This mechanism comprises a piston 25, which is guided and slides axially in said chamber, equipped with a hollow stem 26 facing towards and housing, the guide shank 20, and is stressed by at least one thrusting device to progressively move it forward.

The thrusting device, made up for example by a pre-loaded spring 27, placed around said guide shank 20 and in said stem 26 and held between the head wall of the proximal cylinder and the piston. Otherwise the thrusting device can be made up of compressed gas inserted in the chamber 24, between the head wall and the piston.

The piston 25 is coupled forming a seal with the internal surface of the chamber 24 formed by the proximal cylinder 17. Longitudinally, from one side of the stem 26 of the piston is envisaged a metering plate 28 with two parallel columns of teeth: one column of teeth for metering 29 and one for controlling 30. The teeth of each column are uniformly aligned and spaced, however with the teeth of the metering column staggered in contrast to the teeth of the control column. On one side of the proximal cylinder 17 an opening designed to receive the control pushbutton 13 is provided. This pushbutton is positioned and moveable crossways in front of the plate 28 with the two metering and control, 29,30 columns of teeth respectively. Said pushbutton 13 is activated by a spring 31 and supplied with a pawl 32 designed to engage alternately with a tooth of the metering teeth column 29 and a tooth of the control teeth column 30 to move forward in step with the piston.

The distal cylinder 18, when coupled to the proximal cylinder 17, forms a load tank 33, with a volume from between the piston 25 and the single-acting valve 14 and designed to receive an initial quantity of fluid of different viscosities to be delivered in doses.

In the example in the drawings, the single-acting valve 14 comprises a valve body 34 that connects up to the free end of the distal cylinder and an obturator 35 activated by a spring 36. In particular, the valve body 34 forms a transit chamber 37 of the fluid from the load tank 33 to the collection tank 15 designed to then feed the applicator 16.

This transit chamber 37, on one side, is in communication with the load tank 33 through a valve seat 38 provided in a wall basically forming the bottom of said tank 33 and, on the other side, has a base wall with bore 39 through which it is in communication with the collection tank 15.

The obturator 35 is associated with the valve seat 38 and, thrust by the relative spring 36, is maintained normally in a closed position of the seat to stop the fluid substance from exiting from the load tank 33.

It should be noted that the collection tank 15, preferably conical in shape, has outlet passages 40 of the fluid substance towards the applicator 16 and can be equipped with a safety valve.

The applicator can have various configurations.

Indicatively, but not restrictedly, the applicator can be brush, pad, cannula type, in the shape of a toothbrush, etc., depending on the way it is required to be used and the application of the substance delivered. Furthermore, the device described can be equipped with a protective cap 41 which can be fitted on the single-acting valve and/or on a closing cap 42 on the collection tank and housing the applicator when associated with said tank.

Knowing the volume of the load tank, the distances between the teeth 29, 30 on the metering plate 28 will be selected based on the quantity of fluid substance making up the dose to be delivered at each forward movement of the piston.

Practically, the forward step by step movement of the piston 25 is established by the pre-loaded spring 27 and is carried out each time by using the control pushbutton 13 to release it from a tooth 29 it is engaged with at that moment and to make it engage with the following tooth 30 so as to automatically block the piston after it has moved forward.

Initially, the piston 25 is moved back to oppose the action of the spring 27 and stopped in that position by the pushbutton 13, the pawl 32 of which is engaged with a first tooth 29 (the one closest to the piston) of the metering plate.

To deliver the fluid substance introduced into the distal cylinder 18 to be used by the applicator 16, simply adopt the control pushbutton 13 so that it will release the piston 25 which, thrust by the relative spring 27, moves a step forward generating a pressure on the substance so as to push it towards the single-acting valve 14. This pressure then causes the single-acting valve to open and consequently the substance to flow through the bore in the bottom wall of the valve body into the collection tank 15 and from here to the applicator 16 to be delivered as required.

For substances such as gels, emulsions, monobasic hydrophile solutions and similar of greater viscosity, the single-acting valve can be replaced by a bored bottom 43, so that the dose of the substance to be delivered, always due to the thrust of the piston, will be able to pass from the load tank formed by the distal cylinder to the collection tank through the holes in said bottom which can be specially calibrated. Furthermore, the device can be prepared and used also for metering solid substances and substances in powder form with different granulometry.

In any case, the dose of the substance to be delivered and used is calibrated by an identical and preset forward movement of the piston thanks to the regular action of the pre-loaded spring and the control of the toothed metering plate each time the latter is released by the use of the control pushbutton.

1. A device for dispensing doses of fluid substances with different viscosity or density, such as solutions, emulsions, gels and the like to be used by an applicator, the device comprising:
a container cylinder with a proximal closed end and an open distal end, wherein a portion of said container defines a chamber, said portion of said container being contiguous to said closed end;
a piston located in said chamber, said piston being moveable within said chamber;
a load tank for containing a fluid substance to be dispensed, said load tank being formed by a remaining portion of said container;
a metering mechanism positioned in said chamber, associated and moving with the piston in said container;
a pre-loaded thrust means associated with said piston and said metering mechanism for moving said piston towards the fluid substance in said load tank;
a blocking means located between the metering mechanism and the container cylinder for alternately stopping and releasing said piston at regular forward intervals, each interval corresponding to a delivery dose amount of fluid substance delivered from a distal end of the load tank towards an applicator detachably attached to the container cylinder.

2. A device according to claim 1, wherein a single-acting valve and/or a collection tank are assembled between an open end of the load tank and the applicator.

3. A device according to claim 1, wherein a bottom with calibrated or countersunk bores, depending on the type of substance to be metered, is assembled between an open end of the load tank and the applicator.

4. A device according to claim 1, wherein the container cylinder comprises a proximal cylinder and a distal cylinder, said proximal cylinder having a proximal cylinder contiguous end, said distal cylinder having a distal cylinder contiguous end, said proximal cylinder contiguous end being coupled with said distal cylinder contiguous end, and wherein the proximal cylinder forms the housing chamber of the piston with the metering mechanism, and the distal cylinder forms the load tank of the fluid substance and directly or indirectly holds the applicator.

5. A device according to claim 2, wherein the single-acting valve has a valve body coupled with said open distal end of the container cylinder and an obturator activated by a closing spring, said valve body forming a transit chamber, said transit chamber receiving of the fluid substance from the load tank, said collection tank receiving fluid substance from said transit chamber, said collection tank delivering the fluid substance to the applicator, said transit chamber being in communication with the load tank on one side via a valve seat defined in a wall substantially forming a bottom portion of said load tank, said transit chamber having a bored base wall on another side such that said transit chamber is in communication with the collection tank, said obturator being associated with said valve seat, said obturator moving via said closing spring to a closed position such that said obturator closes said valve seat to prevent the fluid substance from exiting the load tank.

6. A device according to claim 5, wherein the piston has a hollow stem sliding along an axial guide shank, said axial guide shank extending from the proximal closed end of the container cylinder, said metering mechanism being associated with said axial guide shank, said metering mechanism extending along one side of the hollow stem of said piston.

7. A device according to claim 6, wherein the metering mechanism comprises a plate attached to the hollow stem of said piston, said plate supporting a column of metering teeth and a column of control teeth, said column of metering teeth being parallel to said column of control teeth, said teeth of each column being uniformly aligned and spaced, said teeth of the metering column being staggered at regular intervals with respect to said teeth of the control column.

8. A device according to claim 1, wherein the preloading means comprises at least one spring positioned between a guide shaft and a stem of said piston.

9. A device according to claim 1, wherein the preloaded thrust means is a compressed gas placed between the piston and the proximal closed end of the container.

10. A device according to claim 7, wherein the blocking means comprises a spring pushbutton inserted in the container, said pushbutton being oriented in a transverse direction of said metering mechanism, said pushbutton having a pawl, said pawl engaging alternately with a tooth of the metering teeth column and a tooth of the control teeth column 30 such that said spring button controls forward movement of said piston in set stages.

11. A device according to claim 1, wherein a single-acting valve controls delivery of a dose amount of fluid substance from the load tank to a collection chamber through the open end of said container, said single-acting valve being moveable from a closed position to an open position, said single-acting valve being in said open position when said piston exerts pressure on the fluid substance via the pre-loaded thrust means.
